(19) United States
(12) Patent Application Publication
(10) Pub. No.: US 2025/0277958 A1
(43) Pub. Date: Sep. 4, 2025

(54) ATHERMAL OPTICAL FRAMEWORKS

(71) Applicant: Applied Research Associates, Inc., Albuquerque, NM (US)

(72) Inventors: Joseph N. Paranto, Albuquerque, NM (US); Michael E. Meline, Albuquerque, NM (US); Devin M.J. Todd, Orlando, FL (US); Matthew Flint Kepler, Austin, TX (US); Martin William Slack, Edgewood, NM (US)

(21) Appl. No.: 18/816,520

(22) Filed: Aug. 27, 2024

Related U.S. Application Data
(63) Continuation of application No. 17/325,982, filed on May 20, 2021, now Pat. No. 12,111,511.

(51) Int. Cl. G02B 7/02; G02B 7/00; H04N 23/55

(52) U.S. Cl. CPC G02B 7/028; G02B 7/021; H04N 23/55; G02B 7/008

(57) ABSTRACT

Configurations and compositions for frameworks supporting optics such as lenses are described that provide an invariant structure regardless of temperature swings, thereby maintaining alignment and focus. Frameworks may comprise tiered structures of materials having multiple distinct coefficients of thermal expansion. An optical framework includes a first framework portion coupled to a first lens and a second framework portion coupled to a second lens. The first framework portion and second framework portion comprise materials having a coefficient of thermal expansion such that expansion of the first framework portion in one direction is offset by expansion of the second framework portion in an opposite direction.

### CROSS-REFERENCE TO RELATED APPLICATIONS

This patent application is a continuation application claiming priority benefit, with regard to all common subject matter, of U.S. patent application Ser. No. 17/325,982, filed May 20, 2021, and entitled “ATHERMAL OPTICAL FRAMEWORKS.” The above-referenced application is hereby incorporated by reference in its entirety into the present application.

### STATEMENT OF GOVERNMENTAL SUPPORT

This invention was made with government support under ONR Contract #N00014-17-C-7022 awarded by the United States Office of Naval Research. The government has certain rights in the invention.

### BACKGROUND

### 1. Field

Embodiments of the invention are broadly directed to optical frameworks that minimize the deleterious effect of thermal expansion and contraction on aligned lenses or other optical elements. Specifically, embodiments of the invention employ a plurality of materials of varying lengths and thermal expansion coefficients that result in a net-zero displacement despite undergoing a change in temperature. Embodiments may be configured to provide athermal optics for a weaponized laser generation system, such as that described by U.S. Pat. No. 10,900,755, the description of which is herein incorporated by reference in its entirety.

### 2. Related Art

Optical elements need to be carefully aligned via a supporting optical framework to accurately focus incoming or outgoing light to a desired target. Examples include a telescope, which focuses incoming light, and laser optical outputs, which focus an outgoing beam of light. The distance between lenses of a telescope must be calibrated such that captured light is focused on a target. Targets of simple telescopes may be the retina of the human eye. More sophisticated telescopes may target a light-sensitive image capture device, such as a CCD. If the careful alignment of the lenses is lost, the image is blurred, and the telescope may be damaged. Similarly, laser optics refocus an outgoing beam of lased light. The high-energy laser is spread to an appropriate beam width and directed at a desired target. If alignment of the lenses is lost, the intensity of the beam suffers and, in the case of a weaponized laser, it may no longer function at a high enough power level to produce the desired effect.

A particular source of alignment loss often encountered is expansion or contraction of the materials used to support and align the lenses due to a change in ambient temperature. Returning to our previous examples, telescopes that are aligned on earth and then transported to the cold of space experience significant thermal contraction, while laser optics aligned at room temperature experience significant thermal expansion while in use due to heating from the laser. Accordingly, there is a need for optical frameworks that negate the deleterious effects of thermal expansion and contraction, preserving alignment between optical elements despite ambient temperature swings.

### SUMMARY

Embodiments of the invention address this need by providing frameworks for supporting and/or aligning optical elements via configurations and materials that negate expansion and contraction experienced due to a change in temperature. Embodiments of the invention may be formed of a plurality of distinct portions composed, completely or primarily, of distinct materials having distinct coefficients of thermal expansion. Framework portions may, in some embodiments, be tiered such that the framework portion “steps down” in a wedding cake-like structure from a large circumference to a smaller circumference. Specifically, in some embodiments, a longer framework portion may have a smaller coefficient of thermal expansion than a shorter framework portion.

In a first embodiment, an optical assembly comprises a framework having a first framework portion coupled to a first lens and a second framework portion coupled to a second lens. The first and second framework portions are formed of distinct materials such that thermal expansion of the first framework portion is equal and opposite to thermal expansion of the second framework portion. The first framework portion may be formed of a plurality of tiers, with the largest tier being coupled to the first lens and the smallest tier being the closest tier to the second portion. In some embodiments, the second lens is surrounded in two dimensions by at least a part of the first framework portion.

In a second embodiment, an optical assembly comprises a framework aligning a first lens with a second lens. The second portion is formed of a material having a greater coefficient of thermal expansion than that of the material forming the first portion, and the length of the first portion is greater than that of the second portion. As a result, thermal expansion of the first portion is equal and opposite to the thermal expansion of the second portion. The first framework may be formed of three rods, though in some embodiments any number of rods may be used. The rods of one tier may align with those of adjacent tiers, or may intentionally not align with the rods of other tiers in order to increase strength.

In a third embodiment, a lens alignment system comprises a longer first portion having a first coefficient of thermal expansion and shorter second portion having a second coefficient of thermal expansion greater than the first coefficient of thermal expansion. The framework aligns the lenses at a particular spaced apart distance. The first portion and said second portion are arranged such that the distance between the lenses remains constant throughout an operating temperature range of the system. The first portion may be formed of a plurality of tiers, which may each have a unique circumference.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware structure for a first embodiment of the invention;

FIG. 2A depicts a cross-sectional diagram of an embodiment of the invention;

FIG. 2B depicts a cross-sectional view of an embodiment of the invention.

FIG. 3 depicts an embodiment of the invention coupled to a firearm;

FIG. 4 depicts a conceptual diagram of an optical framework of the invention coupled to a laser beam generator;

FIG. 5 depicts an embodiment of a ring for coupling tiers of an optical framework portion in an embodiment of the invention;

The drawing figures do not limit the invention to the specific embodiments disclosed and described herein. The drawings are not necessarily to scale, emphasis instead being placed upon clearly illustrating the principles of the invention.

### DETAILED DESCRIPTION

Embodiments of the invention are directed to systems for supporting and aligning optical elements, such as lenses, in a manner that reduces the effect of thermal expansion and contraction. Embodiments of the invention first address these issues by providing portions of distinct lengths and coefficients of thermal expansion, wherein thermal expansion of one portion is offset by the thermal expansion of another portion in the opposite direction. Specifically, the ratio of the length of the first framework portion to the length of the second framework portion may be inversely proportional to a ratio of the coefficient of thermal expansion of the first framework portion to the coefficient of thermal expansion of the second framework portion. Embodiments may further include configurations for improving overall strength of the framework, such tiering and particular coupling arrangements. Specifically, one or more rings may have one or more bolt holes drilled through for coupling the tiers of the first framework portion together. This description is intended as an example of embodiments of the invention and is not intended to be limiting.

The subject matter of embodiments of the invention is described in detail below to meet statutory requirements; however, the description itself is not intended to limit the scope of claims. Rather, the claimed subject matter might be embodied in other ways to include different elements, structures, steps, or combinations of steps similar to the ones described in this document, in conjunction with other present or future technologies. Minor variations from the description below are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

### EMBODIMENTS OF THE INVENTION

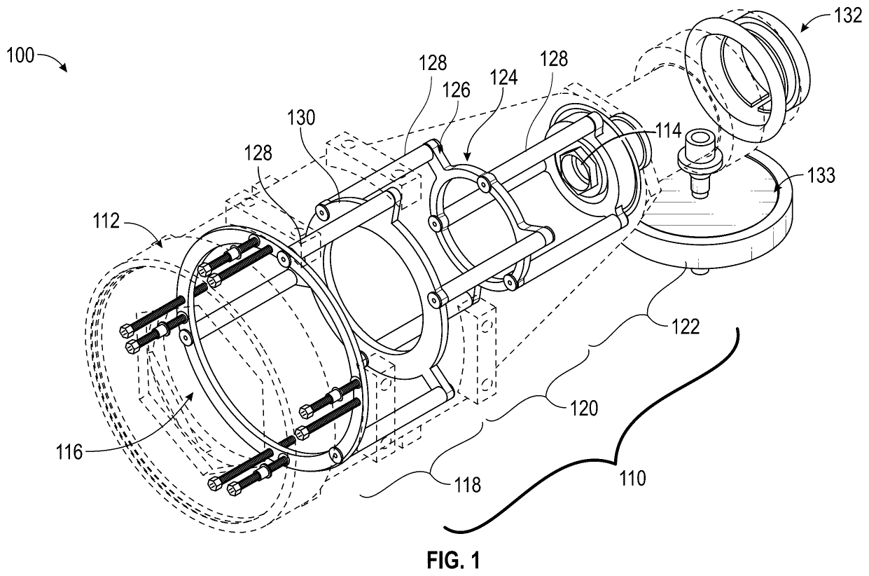

Turning first to FIG. 1, an exemplary optical framework 100 comprises a first framework portion 110 coupled to a first lens 114 and a second framework portion 112 coupled to a second lens 116. The optical framework 100 may additionally or alternatively support any number of optical elements, such as lenses, mirrors, windows, and/or beam splitters, affixing them and maintaining a calibrated alignment. In some embodiments, optical framework may include three lenses, four lenses, or any number thereof. The first and second framework portions 110, 112 may, in some embodiments, be coupled directly to one another or may be coupled to one or more intermediary framework portions (not shown). In the embodiment illustrated in FIG. 1, the first framework portion 110 comprises a plurality of tiers, each having a distinct circumference. The first framework portion 110 in combination with rings coupling each tier would resemble a wedding cake if stood on end such that the largest tier is at the bottom. FIG. 1 illustrates framework portion 110 having an exemplary three tiers: 118, 120, and 122. An exemplary rod providing a portion of the structure of a tier is labeled 128, which in this case is illustrated as being in the second tier 120. Any tier of embodiments may comprise any number of rods 128 of any appropriate length, material, or spacing.

In the particular embodiment illustrated in FIG. 1, first tier 122 comprises three rods 128 connected to a first ring 124, second tier 120 comprises three rods 128 between ring 124 and ring 130, and third tier 118 comprises three rods 128 connected to ring 130 and a second framework portion 112. In some embodiments, the rods 128 are offset between tiers 118, 120, 122 such that rods of any particular tier do not align with rods of adjacent tiers at a ring to which each adjacent tier is coupled. In embodiments, each tier may have a distinct circumference, while in other embodiments at least two tiers may have equal circumferences.

In some embodiments, the first framework portion 110 may have any number of tiers, or may not be configured in a tiered formation at all. For instance, in some embodiments, the framework may smoothly taper in a conical shape. In other embodiments, the framework may have an exterior cylindrical shell with an inset framework portion. In some embodiments, air filter 133 may be included to allow air pressure equalization within the optical assembly when fiber connector 134 or other receiver is inserted therein.

Specific embodiments may have precisely three tiers or four tiers, or any number of desired tiers. In some embodiments, the largest circumference tier 118 of the first framework portion 110 may be coupled to or nearest to the second framework portion 112. In some embodiments, the smallest circumference tier 122 of the first framework portion 110 may be coupled to or nearest to the first lens 114. In some embodiments, tiers of the first framework portion 110 may be concentric. In other embodiments, the tiers of the first framework portion 110 may be non-concentric. In some embodiments, the relative length of each tier may be the same as the relative circumferences, such that the tier with the largest circumference has the longest length and the tier with the smallest circumference has the shortest length. Alternatively, the relative length of each tier may be inversely proportional to the relative circumferences, such that the tier with the largest circumference is the shortest and the tier with the smallest circumference is the longest. These are intended only as examples. Tiers may be of any combination of lengths and circumferences in some embodiments of the invention.

In some embodiments, consecutive tiers of a portion of the optical framework may be coupled by rings, such as ring 124. As will be discussed in further detail below, rings 124 may be formed of a third material. The third material of one or more rings 124 may be distinct from the first material comprising the first framework portion 110 and distinct from the second material comprising the second framework portion 112. Specifically, the third material of the rings 124 may have a coefficient of thermal expansion that is distinct from the first framework portion 110 material's coefficient of thermal expansion and the second framework portion 112 material's coefficient of thermal expansion. In some embodiments, the third coefficient of thermal expansion may be greater than the first coefficient of thermal expansion and/or less than the second coefficient of thermal expansion.

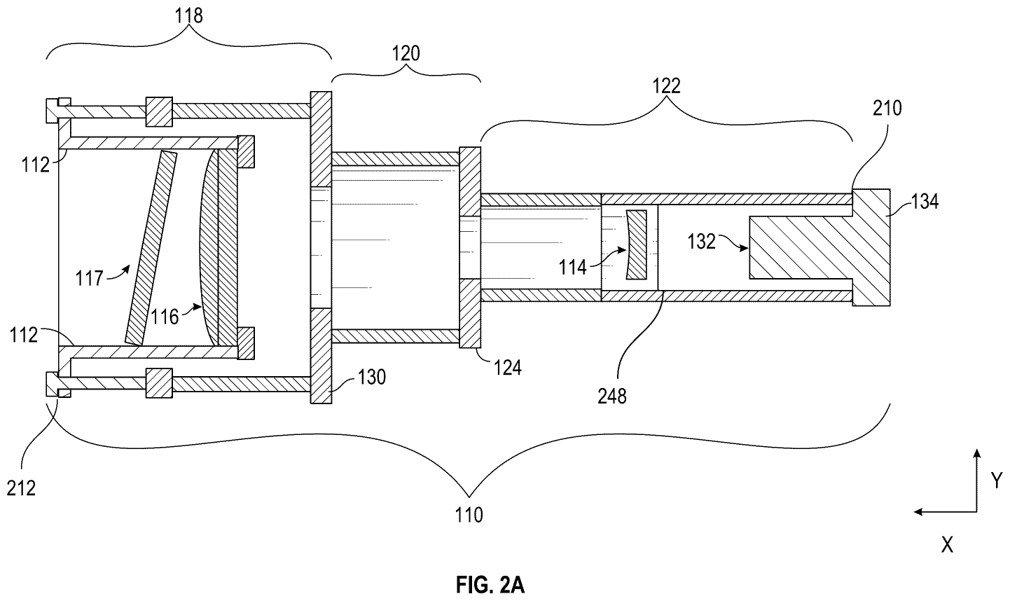

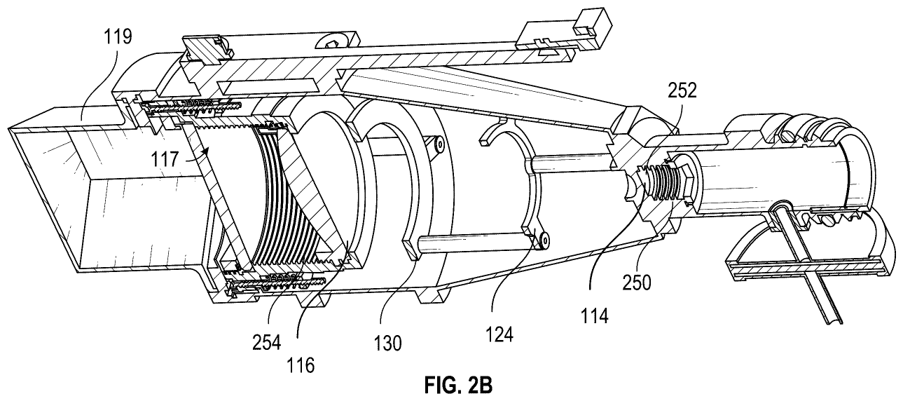

FIG. 2A presents a cross-sectional diagram of the embodiment of an athermal optical framework of FIG. 1. Dimensions of particular elements have been exaggerated for clarity of description. A first portion of the optical framework 110 is formed of three tiers 118, 120, and 122 adjoined by a first ring 124 and a second ring 130. In some embodiments, rings 124 and 130 may be identical or may have distinct circumferences and/or widths. The set of all rings in an embodiment may be referred to as a third framework portion. In the embodiment illustrated in FIG. 2A, the total length of the first framework portion 110 extends from a point 210 at which it terminates at a connection with a fiber connector 134 to a point 212 at which it is coupled to second framework portion 112. Embodiments may have more or fewer tiers, or none at all. Second framework portion 112 is illustrated as much longer in FIG. 2A than in FIG. 1 for illustration purposes. In some embodiments, the first framework portion 110 and second framework portion 112 may be of any given length, though advantageously the lengths of the first and second framework portion 110, 112 may be selected to have a particular mathematical relationship relative to their corresponding coefficients of thermal expansion. This will be discussed in further detail below.

As can be seen in FIG. 2A, first framework portion 110 may couple to first lens 114 while second framework portion 112 may couple to second lens 116. Lenses 114, 116 may be coupled to framework portions 110, 112 by one or more O-rings, additional intermediary framework structures, and/or epoxy, or other mechanical means. Fiber connector 134, in some embodiments, may be a titanium coupling to a laser beam generator, terminating at a laser emitting fiber tip 132. A generated laser may be emitted from tip 132, which is then refocused by lenses 114 and 116 before being directed towards a target through output window 117. In embodiments in which the optical assembly is used for a telescope or other light collector, fiber tip 132 may act as a receiver for incoming light. When not in use, cover 119 may be removably attached around the base of first framework portion 110, such as by screws, fasteners, integrated threading or other mechanical attachment, to protect the lens assembly. Cover 119 may be formed of a high-durability plastic, metal, or other appropriate material.

FIG. 2B depicts another cross-sectional view of the first embodiment of the invention. In some embodiments, one end of tier 122 of first framework portion 110 comprises a cylinder 248 having a wall 250 with an outer surface and an inner surface 252. In some embodiments, the inner surface 252 may contain grooves or ridges that may be operable to support and/or affix first lens 114. In some embodiments, grooves or ridges along the inner surface 252 may act as baffles to ensure that reflected light (such as from first lens 114) does not return and cause damage to fiber tip 132. In some embodiments, the cylinder 248, may comprise aluminum, which may connect to rods 128 of first tier comprising a second material, as discussed herein. In some embodiments, inner surface 252 may be smooth. Similarly, second framework portion 112 is depicted as containing grooves or ridges on an inner surface 254 that may be operable to support and/or affix second lens 116, while in some embodiments, the inner surface of the second framework portion 112 may be smooth. The first framework portion 110 comprises the set of tiered rods arranged around rings stepping up in size from the small spacing circumference about the first lens 114 up to a larger spacing circumference arrangement at a connection with the second framework portion 112 which surrounds second lens 116. Because the rods 128 of the first framework portion 110 are formed of a material having a much lower coefficient of thermal expansion than the coefficient of thermal expansion of the material forming the second framework portion 112, the first framework 110 portion is much longer than the second framework portion 112. As illustrated in FIG. 2B, the second framework portion 112 may comprise molded polyoxymethylene surrounding second lens 116, while the rods of first framework portion 110 may comprise a material with a very low coefficient of thermal expansion, such as Invar®.

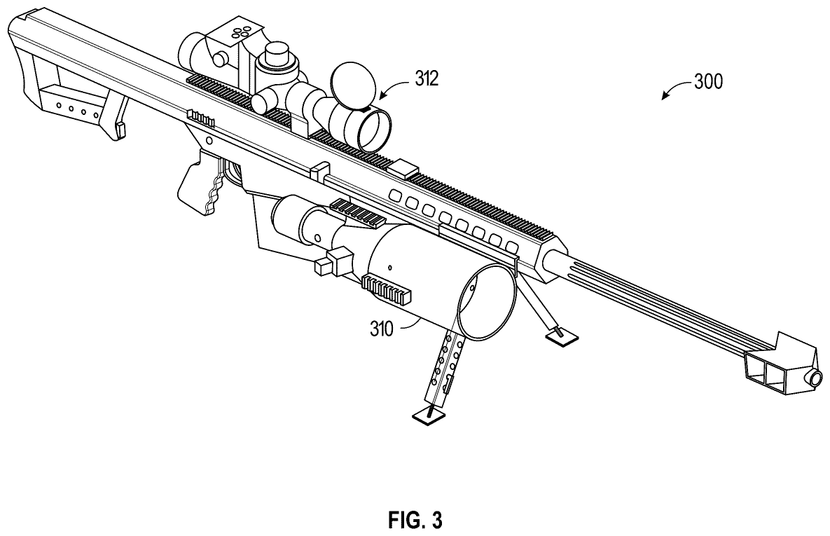

As illustrated in FIG. 3, embodiments of the invention may be used to align and support lenses, windows, and/or other optical elements for an athermal optical output of a weaponized laser beam. A lens alignment system comprises an optical framework 100, such as shown in FIGS. 1-2, surrounded by a protective shell 310, which may be made of a metal, ceramic, or highly durable plastic, in some embodiments. The overall optical output element 100 is illustrated as being mounted to a firearm 300, though embodiments may alternatively be permanently or removably mounted to a building, ground, air, or water vehicle, gimble, actuator, worn apparatus, autonomous or semi-autonomous vehicle, or may be unmounted. In some embodiments, a targeting optical element 312 may be additionally provided. A targeting optical element 312 may be affixed directly to the optical output element 100, in some embodiments, to assist in directing an emitted laser. In other embodiments, a targeting optical element 312 may be provided uncoupled to optical output element 100.

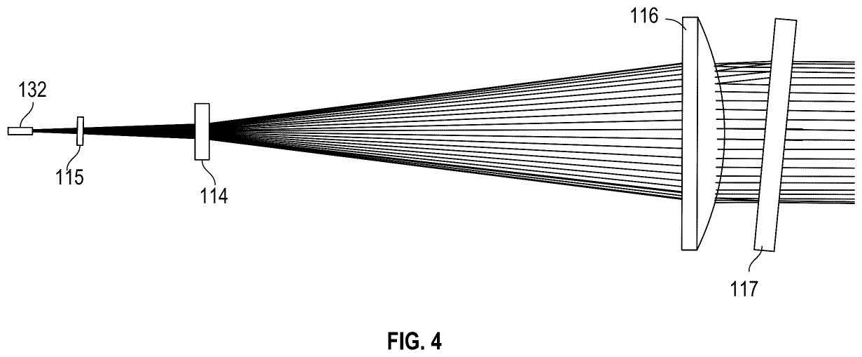

As illustrated in FIG. 4, a laser beam may be configured to couple, in some embodiments of the invention, via a fiber connector 134 to the optical framework 100, which serves to refocus and direct the laser through a laser connection window 115 toward an intended target via a first lens 114 and second lens 116. In some embodiments, the fiber connector 134 may comprise titanium. In some embodiments, the fiber connector 134 may be attached to first framework portion 110. In some embodiments, the attachment may be by a threaded connection and/or any other appropriate connection, including epoxy. First framework portion 110 is coupled to second framework portion 112. In some embodiments, the coupling of the first framework portion 110 to second framework portion 112 may be via bolts and/or any other appropriate manner, including epoxy. In some embodiments, the bolts may comprise stainless steel or another metal. In some embodiments, the bolts may be threaded. In other embodiments, the bolts may be unthreaded.

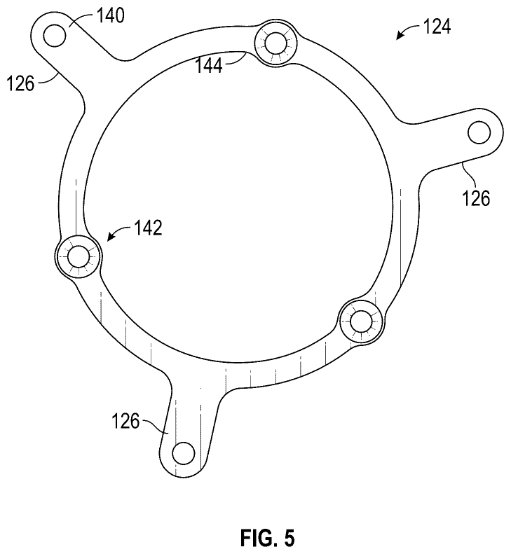

Turning to FIG. 5, in some embodiments, one or more rings 124 may have flanges 126 for coupling consecutive tiers. In some embodiments, rings 124 may have three flanges 126, as illustrated, each having a bolt hole 140 through which bolts may be received to couple rods 128 and consecutive tiers. Embodiments may have any number of flanges, including zero, and may be additionally or alternatively coupled by other methods including epoxy or welding. In some embodiments, bolts and/or rods comprise stainless steel, a nickel-iron alloy, other metals, or any other appropriate material or combinations thereof. Additionally or alternatively, secondary bolt holes 142 may be located on the inner body 144 of the ring 124. In some embodiments, one or more bolt holes 142 and/or bolt holes 140 may be reinforced by additional or alternative material about its circumference.

In particular embodiments, one or more rings may be provided to act as a light baffle to reduce unwanted stray light in a region about the ring 130. In addition, ring 130 may be configured to act as a baffle. An example of ring 130 is illustrated in FIG. 1. Ring 130 may have a width of the inner body 144 that is greater than that of ring 124. In some embodiments, in which the optical output element 100 is coupled to a laser beam generator, ring 130 may be used as a baffle to reduce the likelihood that stray photons are reflected back into the laser beam generator fiber tip 132, which may cause damage. In some embodiments, optical output element 100 may have multiple rings 130, which may act as baffles or none at all.

In some embodiments, one or more tiers in the first framework portion 110 may be formed of a plurality of rods 128. In specific embodiments, one or more tiers may comprise three rods 128 disposed evenly around the circumference of ring 124 to which they are affixed. Embodiments may have any number of rods 128 that may be evenly spaced from one another about the circumference of the ring 124 and/or ring 130. In some embodiments, the rods 128 may be unevenly spaced around the circumference of the ring 124 and/or ring 130. In some embodiments, rods 128 of one tier may be offset from the rods 128 forming one or more consecutive tiers such that they do not align with one another in order to increase the overall strength of the optical framework. Rods 128 of consecutive tiers may be displaced at distinct points about the circumference of their respective rings so that they do not align at the radial points about a circle at which they affix to one or more rings 124 of the optical framework. In particular embodiments, no rod 128 may align with any other rod, while in other embodiments, all or some rods 128 may align.

As illustrated in an exaggerated manner in FIG. 2, second framework portion 112 extends back from the distal end of first framework portion 110 towards first lens 114, supporting second lens 116 at a selected focal distance from first lens 114. In an embodiment, the distance between the lenses may be on the order of 100 mm. In some embodiments, the distance is about 100 mm to about 150 mm. In some embodiments, the distance may be about 138 mm. The thermal expansion of the first framework portion 110 during operation will cause the first and second lenses 114, 116 to move farther apart, while thermal expansion of the second framework portion 112 will cause the first and second lenses 114, 116 to move closer together. For appropriately selected materials relative to the respective lengths of the first and second framework portions 110, 112, the result will be a zero net displacement for the first and second lens 114, 116 over any temperature range. The first framework portion 110 and second framework portion 112 are arranged such that thermal expansion of the first framework portion 110 is equal and opposite to thermal expansion of the second framework portion 112. Thus, the first framework portion 110 and said second framework portion 112 are arranged such that thermal expansion of the first framework portion 110 in a first direction is offset by thermal expansion of the second framework portion 112 in the opposite direction.

FIG. 2A illustrates the second framework portion 112 situated fully inside of the largest tier 118 of the first framework portion 110, though in some embodiments it may extend longitudinally within multiple tiers. In some embodiments, at least a portion of the second framework portion 112 is fully surrounded in two dimensions by the first framework portion 110. In some embodiments, a distal portion of second framework portion 112 may protrude from the distal end of first framework portion 110. As the first framework portion 110 expands due to thermal expansion in the positive x-direction as indicated by the illustrated coordinate system of FIG. 2A, the second framework portion 112 expands due to thermal expansion in the negative x-direction, maintaining the alignment of the optical elements 114, 116 through any temperature gradient.

Specifically, in some embodiments, the result of this specifically designed configuration of optical framework elements is that the ratio of the length of the first framework portion 110 to the length of the second framework portion 112 is inversely proportional to the ratio of the coefficient of thermal expansion of the first framework portion 110 to the coefficient of thermal expansion of the second framework portion 112. In some embodiments, the proportionality may be unity, such that the ratio of the coefficient of thermal expansion of the first framework portion 110 to the coefficient of thermal expansion of the second framework portion 112 is equal to the inverse of ratio of the length of the first framework portion 110 to the length of the second framework portion 112.

Materials may be intentionally selected for the first and second framework portions 110, 112 to maintain these desired mathematical relationships. In some embodiments, the length of the first framework portion 110 is substantially longer than the length of the second framework portion 112, such that the first material comprising the first framework portion 110 must have a coefficient of thermal expansion that is lower than the coefficient of thermal expansion of the second material forming the second framework portion 112. In some embodiments, this may be a significant difference, wherein the coefficient of thermal expansion of the second material of the second framework portion 112 is at least 100 times the coefficient of thermal expansion of the first material of the first framework portion 110.

In an exemplary embodiment, the material of the first framework portion 110 comprises a nickel-iron alloy and the material of the second framework portion 112 comprises polyoxymethylene. The nickel-iron alloy in some embodiments may comprise the alloy commonly known as Invar®, Ni36. The material of the first framework portion 110 has a very low coefficient of thermal expansion. The material of the second framework portion 112, in some embodiments, may comprise Delrin®, acetal homopolymer (polyoxymethylene POM). The second material of the second framework portion 112 has a much higher coefficient of thermal expansion than the first material of the first framework portion 110, resulting in the net zero thermal displacement described above. For example, in some embodiments, the length of the first framework portion 110 is much longer than the length of the second framework portion 112. In some embodiments, the third framework portion, which forms the rings 124, 130 connecting the tiers of the first framework portion may be formed of a third material. In some embodiments, the third material comprises aluminum or an aluminum alloy. These exemplary materials are intended only as specific examples and the invention is not limited thereto. Any appropriate materials may be utilized in some embodiments of the invention. For example, in some embodiments one or more of the first, second, or third portion of the optical framework may comprise titanium, stainless steel, fused silica, ceramics, sapphire, or other materials resistant to high temperature environments. Additional materials utilized may include alloys or combinations of any of the materials discussed and/or other materials.

In some embodiments, materials of the particular framework portions may be selected such that the coefficient of thermal expansion of the material of the second framework portion 112 and the coefficient of thermal expansion of the material of the third framework portion are each at least four times the coefficient of thermal expansion of the material of first framework portion 110. In specific embodiments, the coefficient of thermal expansion of the first material of the first framework portion 110 may specifically be in a range from about 0.5×10⁻⁶ m/m/K to about 2×10⁻⁶ m/m/K. In some embodiments, the coefficient of thermal expansion of the second material of the second framework portion 112 may specifically be in a range from about 100-115×10⁻⁶ m/m/K. In some embodiments, the coefficient of thermal expansion of the third material of a third framework portion including the rings 124, 130 coupling tiers of the first framework portion 110 may specifically be in a range from about 20-25×10⁻⁶ m/m/K. In a specific embodiment, the first framework portion comprises Invar®, which has a coefficient of thermal expansion of about 1.26×10⁻⁶ m/m/K, the second framework portion comprises Delrin®, which has a coefficient of thermal expansion of about 110.0×10⁻⁶ m/m/K, and the third framework portion comprises aluminum, which has a coefficient of thermal expansion of about 23.6×10⁻⁶ m/m/K at an operating temperature.

As will be understood by persons of skill, coefficients of thermal expansion often display a temperature dependence. A coefficient of thermal expansion for a given material in this description is intended to be understood, then, as the average coefficient of thermal expansion for the material over an operational temperature range. The operational temperature range may vary widely for various applications of the invention. For example, in an application where an embodiment of the invention is being used as an athermal optical output for a high-energy laser weapon, the optical framework that is fabricated, assembled, and aligned at room temperature may experience temperatures of over 50° C. while the laser is being fired. However, in an application where an embodiment of the invention is being used as part of a space-based telescope assembly, the optical framework that is fabricated, assembled, and aligned at room temperature may experience temperatures of below −270° C. when outside of Earth's atmosphere. Embodiments of the invention may provide optical frameworks that are configured to provide optical alignment of a plurality of lenses over either of these temperature gradients, using lengths of respective framework portions that are calculated using the average coefficient of thermal expansion over the respective application's entire operating range. As a specific example, in an application in which the ambient temperature may vary from about −20° C. to about 60° C., the coefficient of thermal expansion for a given material should be understood to be the average coefficient of thermal expansion for that material over the range of about-20° C. to about 60° C.

As discussed above, embodiments of the invention may be configured to permanently or detachably couple to a laser beam generator. In some embodiments, the optical framework may be surrounded by an encasing protective shell and/or may be configured to include additional elements such as iron sights or controls for adjusting the focus of the lenses. Embodiments of the invention may be configured to interface with a quick release attachment system, such as a picatinny rail mounting system. Embodiments may be configured to couple to one or more actuators for automatic target acquisition, which may be performed under the control of a processor and/or user controls. Additionally, or alternatively, actuators may further help compensate for thermal displacement, which may be done in response to the output of a temperature sensor. Additionally, or alternatively, embodiments may be configured to couple to one or more tripods or gimbles, or to a vehicle, which may be at least semi-autonomous. Embodiments may comprise any number of any type of optical elements not expressly illustrated or described including but not limited to lenses, mirrors, windows, and/or beam splitters. Embodiments may be configured to couple to one or more cameras.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed, and substitutions made herein without departing from the scope of the invention as recited in the claims. For example, though an optical framework 100 is described primarily with regards to a laser beam optical output, embodiments may be equivalently applicable to telescope, microscope, seeker for a guided missile, or any other optical applications. Any implementation that seeks to maintain optical alignment throughout a temperature range is intended for inclusion within embodiments of the invention.

Having thus described various embodiments of the invention, what is claimed as new and desired to be protected by Letters Patent includes the following:

1. An optical assembly, comprising:
a framework, comprising:
a first framework portion comprising a first material having a first coefficient of thermal expansion;
a second framework portion comprising a second material having a second coefficient of thermal expansion greater than the first coefficient of thermal expansion; and
a third framework portion comprising a third material distinct from the first material and the second material and having a third coefficient of thermal expansion greater than the first coefficient of thermal expansion; and
a first optical element and a second optical element aligned via the framework.

2. The optical assembly of claim 1,
wherein the third framework portion comprises a first ring and a second ring distally from the first ring, and
wherein a first width of the first ring is greater than a second width of the second ring.

3. The optical assembly of claim 1, wherein the first framework portion and the second framework portion align with the first optical element and the second optical element such that a distance between the first optical element and the second optical element remains constant throughout an operating temperature range of the optical assembly.

4. The optical assembly of claim 1,
wherein the first framework portion comprises a plurality of concentric tiers, and
wherein the third framework portion comprises at least one ring adjoining the plurality of concentric tiers.

5. The optical assembly of claim 1,
wherein a first thermal expansion of the first framework portion causes the first optical element to move apart from the second optical element, and
wherein a second thermal expansion of the second framework portion causes the first optical element to move towards the second optical element.

6. The optical assembly of claim 1, further comprising a fiber connector that terminates at the first framework portion and is configured to direct a laser towards an intended target via the first optical element and the second optical element.

7. The optical assembly of claim 1, wherein the first framework portion further comprises:
ridges or grooves configured to support the first optical element and to block light reflected from the first optical element.

8. An optical assembly, comprising:
a first framework portion, comprising:
a first material having a first coefficient of thermal expansion,
a plurality of concentric tiers comprising a plurality of rods,
wherein the plurality of rods of one of the plurality of concentric tiers are offset from the plurality of rods of an adjacent concentric tier;
a second framework portion comprising a second material having a second coefficient of thermal expansion distinct from the first coefficient of thermal expansion; and
a first optical element coupled to the first framework portion; and
a second optical element coupled to the second framework portion.

9. The optical assembly of claim 8,
wherein the first framework portion has a first length that is greater than a second length of the second framework portion, and
wherein the first coefficient of thermal expansion is less than the second coefficient of thermal expansion.

10. The optical assembly of claim 8, wherein the second framework portion extends longitudinally through at least two of the plurality of concentric tiers of the first framework portion.

11. The optical assembly of claim 8, wherein a first concentric tier of the plurality of concentric tiers has a largest length and a largest circumference, and wherein each successive concentric tier of the plurality of concentric tiers decreases in length and in circumference.

12. The optical assembly of claim 11, wherein the first concentric tier is adjacent to the second framework portion.

13. The optical assembly of claim 8, wherein a concentric tier of the plurality of concentric tiers comprises a largest circumference and a shortest length of the plurality of concentric tiers.

14. The optical assembly of claim 8, wherein at least two concentric tiers of the plurality of concentric tiers have distinct outer circumferences.

15. The optical assembly of claim 8, further comprising:
at least one ring coupling adjacent concentric tiers of the plurality of concentric tiers,
wherein the at least one ring comprises a third material having a third coefficient of thermal expansion distinct from the first coefficient of thermal expansion and the second coefficient of thermal expansion.

16. An optical element alignment system, comprising:
a framework, comprising:
a first framework portion comprising a first material having a first coefficient of thermal expansion; and
a second framework portion comprising a second material having a second coefficient of thermal expansion that is at least 100 times the first coefficient of thermal expansion;
a first optical element coupled to the first framework portion;
a second optical element coupled to the second framework portion.

17. The optical element alignment system of claim 16, wherein the first framework portion comprises a plurality of concentric tiers, and wherein the optical element alignment system further comprises:
a third framework portion comprising at least one ring adjoining the plurality of concentric tiers.

18. The optical element alignment system of claim 17, wherein the third framework portion comprises a third material having a third coefficient of thermal expansion distinct from the first coefficient of thermal expansion and the second coefficient of thermal expansion.

19. The optical element alignment system of claim 16, further comprising a fiber connector that terminates at the first framework portion and that is configured to couple a laser beam generator to the framework.

20. The optical element alignment system of claim 19, wherein the first optical element and the second optical element are configured to refocus a laser generated by the laser beam generator and direct the laser through an output window.
